(19) United States
(12) Patent Application Publication
(10) Pub. No.: US 2007/0200712 A1
(43) Pub. Date: Aug. 30, 2007

(54) Smart RFID reader antennas

(75) Inventors: Michael R. Arneson, Finksburg, MD (US); William R. Bandy, Gambrills, MD (US); Robert Beach, Los Altos, CA (US); Kevin J. Powell, Annapolis, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, MD (US)

(21) Appl. No.: 11/363,279

(22) Filed: Feb. 28, 2006

(51) Int. Cl. G08B 13/14

(52) U.S. Cl. 340/572.8; 340/572.7

(57) ABSTRACT

Devices and systems to interrogate radio frequency identification (RFID) tags are described. Compact and inexpensive interrogation devices are realized by implementing integrated circuit chip-based RFID reader and antenna on a common substrate. The small form-factor devices may be used for quick and easy installation of RFID reader network. In an aspect, the device may be incorporated into hand-held mobile devices in order to serve as a mobile reader. In another aspect, the device may be installed as a shelf-reader or a rack-reader, displaying product-specific information on a display screen. In a further aspect, the device may comprise an appliance, whose operation can be tailored according to instructions received specific to a RFID-tagged item.

### CROSS-REFERENCE TO RELATED APPLICATIONS

The following pending applications of common assignee are related to the present application, and are herein incorporated by reference in their entireties:

“Optimized Operation Of A Dense Reader System,” Atty. Dkt. No. 2319.0230000, U.S. application Ser. No. 11/312,606, filed Dec. 21, 2005; and

“Dense Reader System With Improved Listen Before Talk Communications,” Atty. Dkt. No. 2319.0440000, U.S. application Ser. No. 11/312,494, filed Dec. 21, 2005.

### BACKGROUND OF THE INVENTION

1. Field of the Invention

The present invention relates generally to radio frequency identification (RFID) systems, and more particularly to implementations of RFID readers.

2. Background Art

Radio frequency identification (RFID) technology has become very useful for electronic asset management and security in modern business because it provides a means for comprehensive traceability of assets throughout a business enterprise. RFID technology is based on electronic interaction between RFID tags and RFID readers.

RFID tags are electronic devices attached to physical objects containing information related to the object. RFID readers communicate with tags through one or more antennas to collect information about the presence, identification and location of items such as inventory items, personal or business assets (such as vehicles), or alarm triggered events (such as break-ins at a facility). Today, RFID technology plays a crucial role in real-time inventory management, remote personal access control, and asset loss prevention. Additionally, RFID is being considered as a viable implementation technology for emerging applications such as physical browsing, where an user can interact with information and services available in the user's physical environment by means of pointing or scanning towards a sensor-enabled tagged item, e.g. remotely switching a home appliance on or off.

RFID readers may have relatively short or long range of operation depending on their operating frequency, transmitter power level and specific application requirement. A reader may work as a stand-alone instrument or as part of a RFID reader network. RFID reader networks are often capable of simultaneously reading multiple RFID tags, registering and monitoring the status of the tagged items, and reporting possible malfunctioning, disappearance, or unauthorized movement of objects.

RFID readers are often large in size and expensive. In many cases, they need to be tethered to one or more remote antennas by bulky and costly RF cables. Attempts towards integrating more functionality into a RFID reader usually result in increasing size and power requirements, while decreasing portability. Traditionally, RFID readers are stationary devices capable of monitoring stationary or moving tags within an operational range. Even when the reader is a member of a network, the individual readers and antennas are usually fixed in their locations. This makes reader network installation quite complicated and inflexible. Once installed, the network is not easily reconfigurable to adapt to a dynamically changing physical environment. These drawbacks limit the possible application of RFID technology.

Thus, what is needed are readers having reduced cost and power requirements, and at the same time, having enhanced portability and versatility.

### BRIEF SUMMARY OF THE INVENTION

Methods, systems, and apparatuses for improved radio frequency identification (RFID) readers are described.

In a first aspect of the present invention, a RFID reader is implemented in one or more integrated circuit chips, such as Application Specific Integrated Circuit (ASIC) chips. The chip-based reader is coupled to one or more antennas on a common substrate, which can be packaged within an enclosure. The reader may also include a power interface module. The resulting footprint of the packaged RFID interrogation device is very compact.

In another aspect, the combined reader and antenna is adapted to communicate with a reader network. The combined device is suitable for easily and quickly installing or reconfiguring a reader network.

In a further aspect, the RFID reader is incorporated into or attached to a hand-held mobile terminal, such as a mobile phone, personal digital assistant, or lap-top computer to realize a mobile reader.

In a still further aspect, the RFID reader is installed onto a shelf containing RFID tagged items. The shelf reader may interface with a display module in order to display item-specific information retrieved from a local or remote database. The present invention also describes smart rack reader suitable for retail environment, where the metal rack itself may act as a RFID antenna.

Aspects of the present invention also include appliances having a RFID reader card that reads tags of associated items, and communicates the retrieved tag identification information to a local or remote database. The reader card receives information and/or instructions in response, and controls the operation of the appliance according to the instructions received from the database relevant to the specific tagged item.

In further aspects, RFID readers can be networked, such as through the use of a switch device. One or more of the networked readers can be used to transmit interrogation signals, while one or more others of the networked readers can be used to receive tag responses to the interrogation signals. One or more of the networked readers may perform both interrogation and response reception functions.

Such aspects allow for a population of tags to be read more rapidly, and can enable the handling of tag response contentions. Furthermore, such aspects may allow for locating tags, monitoring movement of tags, determining the presence of rogue readers, and/or determining the presence of interference.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts an environment where an exemplary population of RFID tags is being interrogated by a RFID reader network, according to an embodiment of the present invention.

FIG. 2 illustrates a conventional RFID reader connected to antennas by radio frequency (RF) cables.

FIGS. 3, 4, 5, and 6 show plan views of example smart RFID readers, according to the various embodiments of the present invention.

FIG. 7 shows an exemplary smart RFID reader that can be incorporated into a hand-held device, according to an embodiment of the present invention.

FIGS. 8 and 9 illustrate elevation views of two RFID shelf readers, according to embodiments of the present invention.

FIG. 10 shows a smart RFID reader configured to communicate with an external computer or computer network, according to an embodiment of the present invention.

FIG. 11 shows another exemplary embodiment of the present invention, where a smart RFID reader is configured to interface with a display device.

FIG. 12 shows an exemplary RFID-enabled smart-appliance, according to an embodiment of the present invention.

FIG. 13 shows an example embodiment of a “rack reader” for use in retail environments.

FIG. 14 shows an example networked reader environment, according to an embodiment of the present invention.

The features and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### Introduction

The present invention enhances the scope of possible applications of RFID technology by making RFID tag interrogation devices smaller, cheaper, and easier to install, while improving their functional features. An RFID reader is implemented in one or more integrated circuit chips (e.g., an Application Specific Integrated Circuit (ASIC)) and is mounted to a substrate. One or more antennas are also formed on the substrate, and coupled to the integrated circuit chip(s). This integrated RFID reader and antenna decreases a reader device footprint significantly when compared to the bulky conventional readers available today. Additionally, it is easier to incorporate pre-programmed or programmable logic-based operations into a chip-based RFID reader-antenna combination, so that the device becomes a “smart” or intelligent interrogation and communication device, which can interface with other components of a RFID-enabled system or apparatus.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Furthermore, note that the terms “reader”, “interrogator,” and “interrogation device,” are used interchangeably herein to refer to RFID reader-type devices.

### Example RFID Reader Antenna Embodiments

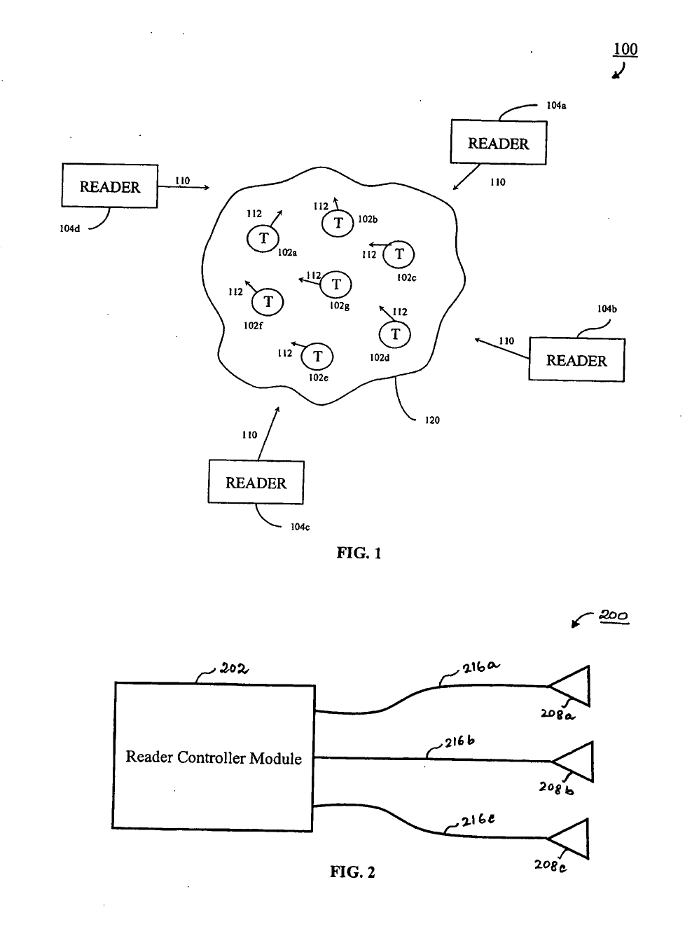

It is useful to begin with the description of an example environment, where the present invention may be implemented. FIG. 1 describes an environment 100, which includes a population 120 of RFID tags 102a-g, and RFID readers 104a-d. Readers 104a-d may operate independently, or may be connected together to form a reader network. Although not shown explicitly in FIG. 1, each of readers 104a-d is coupled to one or more antennas. When a reader 104 transmits an interrogation signal 110 through its corresponding antenna, one or more transponders or tags 102 respond by sending a signal 112 back to the reader. Signal 112 contains tag identification data, that can be decoded by the interrogating reader 104 in order to retrieve relevant information about a tag 102, such as its price, location etc. Signal 112 may contain information about the operational “state” of a tag 102, which help the reader 104 determine the optimum tag interrogation interval, in case multiple readers are configured to interrogate the same population of tags.

Interaction between tags 102 and readers 104 takes place according to certain communication protocols. Examples of such protocols include Class 0, Class 1, and more recently developed Generation 2, all of which are different classes approved by the RFID standards organization EPCglobal (EPC=Electronic Product Code).

FIG. 2 shows further detail of an example conventional RFID reader 200. Reader 200 includes a controller module 202 and a plurality of antennas 208a-c. Controller module 202 typically includes one or more transmitters, one or more receivers, and one or more processors (not shown in FIG. 2). Controller module 202 may have considerable amount of on-board computing power and memory so that it can filter data, store information, run applications, process information, make decisions, and execute commands.

Antennas 208a-c are used by controller module 202 for communicating with tags 102 and/or other readers 104. In conventional readers, antennas 208 are external to controller module 202. In such a configuration, controller module 202 may have one or more ports to connect to antennas 208. Each antenna 208 may be connected to the controller module 202 by a coaxial RF cable 216, or other connection mechanism. Such a combination of controller module 202, cables 216a-c, and antenna 208a-c can cause the complete interrogation device/system to be quite bulky and expensive. For example, an installation of reader 200 requires space for controller module 202 and locations to be selected for antennas 208a-c, and requires cables 216a-c to be run through the local space between controller module 202 and antennas 208a-c. Furthermore, in general, the more functional modules that are included in controller module 202 (e.g., due to interfacing with cables 216a-c, etc.), the larger the device footprint becomes, and the more power-consuming and less portable controller module 202 becomes. The following section describes in details how embodiments of the present invention address and solve these issues.

### Example RFID Reader Antenna Device Embodiments

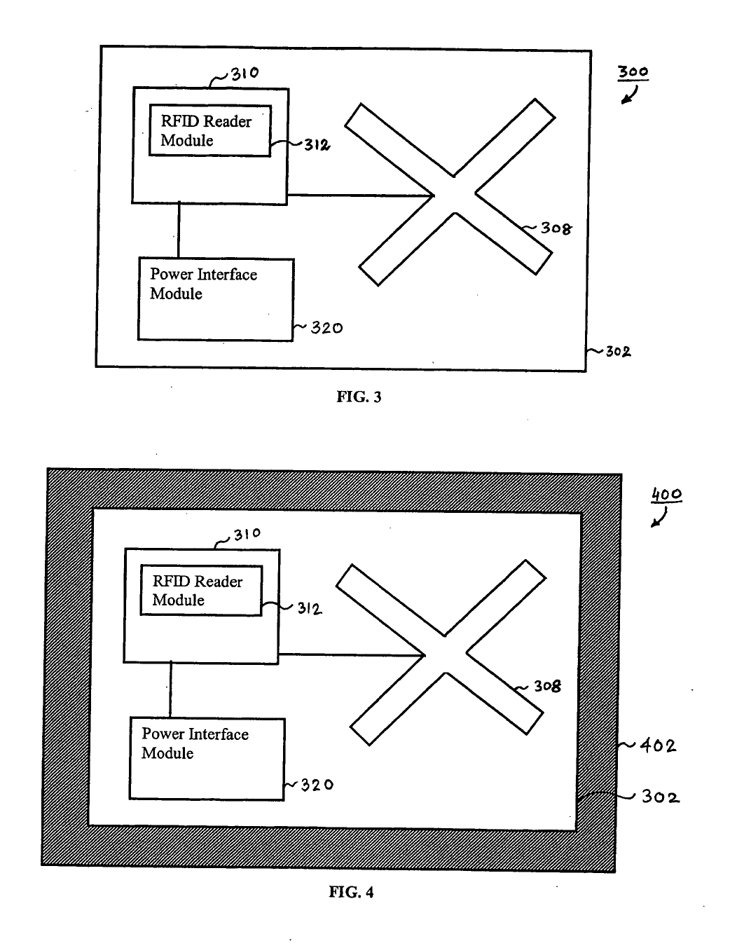

FIG. 3 shows an example embodiment of a RFID interrogation device 300, according to the present invention. Device 300 has a substrate 302 which supports various functional components. Substrate 302 supports/mounts antenna 308 for communicating with RFID tags located outside of device 300, within a range of antenna 308. In an embodiment, there may be more than one antenna 308 on substrate 302, and the one or more antennas 308 can have any antenna configuration/layout. For example, the different antennas 308 may operate at the same or different interrogation frequency bands and/or communication protocols. Antenna 308 may be formed or printed on substrate 302 in any manner, including by using conductive ink, much in the same way that antennas are printed on RFID tags.

Substrate 302 also mounts an integrated circuit (IC) chip 310, which contains the functionality of a RFID reader 312. Although a single IC chip 310 is shown for illustrative purposes in FIG. 3, one or more additional IC chips may be present including functions of RFID reader 312 and/or other functionality of interrogation device 300. IC chip 312 and antenna 308 are coupled to each other, such as by one or more electrically conductive traces on substrate 302. Reader module 312 generates read signals that are transmitted by antenna 308 to RFID tags, and collects tag response signals (such as shown in FIG. 1). Reader module 312 may have built-in intelligence to decode and process response signals on-board, or it may transmit information of the response signals to a remote computer system for processing.

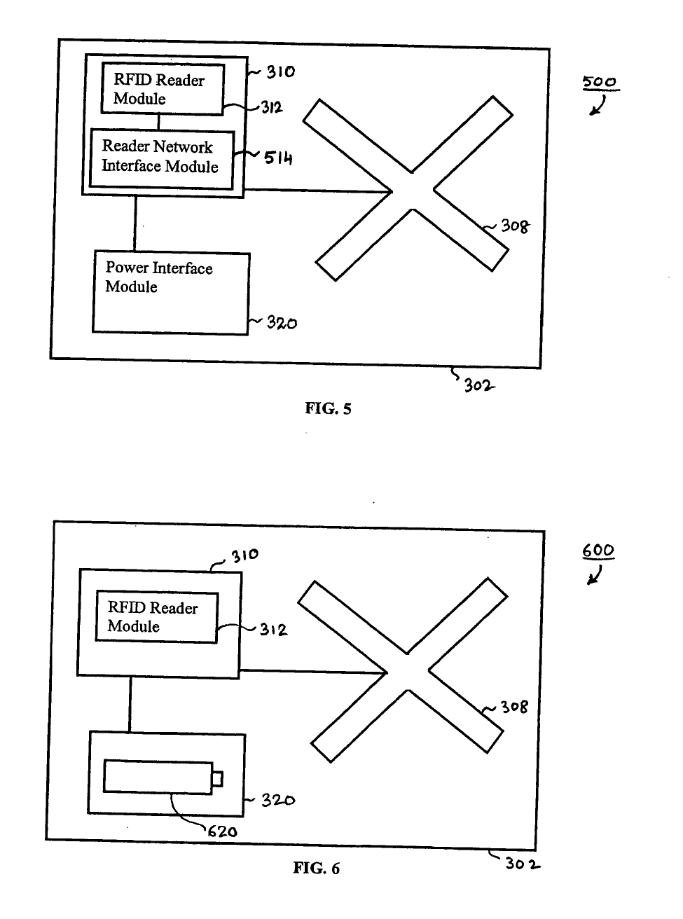

Device 300 also includes a power interface module 320 that supplies electrical power to IC chip 310 and antenna 308. In an embodiment, power interface module 320 is mounted to substrate 302. In an embodiment, power interface module 320 includes one or more batteries. For example, FIG. 6 shows power interface module 320 incorporating a battery 620. In another embodiment, power interface module 320 includes an interface to a power source external to substrate 320. For example, power interface module 320 may include a plug and/or power cord for plugging into an AC outlet. In an embodiment, power interface module 320 draws AC power, and converts the AC power to the appropriate DC voltage level required by IC chip 310 and antenna 308.

IC chip 310 includes circuitry, software, and/or firmware for performing its functions. For example, IC chip 310 may include a processor, an analog-to-digital (ADC) converter, and/or a digital-to-analog (DAC) converter. Having much of the functionality of a reader in IC chip 310 reduces a size of RFID interrogation device 300. For example, IC chip 310 may include a microprocessor module, and a memory/storage module containing data. IC chip 310 may be an Application Specific Integrated Circuit (ASIC) chip so that interrogation device 300 may be termed an ASIC-based “smart” reader. IC chip 310 may be packaged and affixed on substrate 302, and preferably has a small footprint, often in the range of 0.5-1.0 inch on each side. However, IC chip 310 may alternatively have a smaller or larger size. Such ASIC-based readers can be manufactured in large quantities using standard chip fabrication facilities.

The process of attaching chips to antennas on substrate is an important factor in the cost-effectiveness of RFID technology. Integrating the chip-based reader module 312 with antenna 308 on substrate 302 cuts down on assembly time, eliminating a need for separate assembly areas for the antenna(s) and reader controller, which results in a reduced cost for device 300. Furthermore, because IC chip 310 is coupled to antenna 308 on substrate 302 (e.g., using traces, wires), bulky RF cables are not required as in the conventional configuration of FIG. 2. It is appreciated that in an embodiment, antenna 308 may be implemented as an ASIC chip.

FIG. 4 shows an example RFID interrogation device 400 similar to device 300, packaged within an enclosure 402, according to another embodiment. Enclosure 402 may be an environmentally protecting enclosure, which may include an encapsulating material that encapsulates components on substrate 302, a housing structure, and/or other enclosure type. Device 400 may be termed as a “smart” RFID reader antenna. Device 400 can have a small form factor, such as 4.0-5.0 inches on each side, or other sizes. The packaged reader antenna 400 is extremely portable because of its small size. It also requires less power because of the reduced number of components as compared to a conventional reader.

The compact size and easy power adaptability of devices 300 and 400 allows for simplified installation of a reader and/or reader network within a business, service or residential facility, such as a warehouse, a retail store, a healthcare system, a home surveillance system etc. For example, as described above, bulky RF cables are not required to be run throughout a facility. Furthermore, devices 300 and 400 can easily be mounted to a target location that requires RFID coverage in a small form factor format, and can be mounted in apparatuses requiring RFID read functionality.

FIG. 5 shows an interrogation device 500, according to another embodiment of the present invention. As shown in FIG. 5, IC chip 310 of device 500 may include a reader network interface module 514, so that device 500 is adapted to communicate with other readers forming a smart reader network. Interface module 514 may be configured to enable device 500 to communicate directly with other readers, or to communicate with other readers through an intermediate device, such as a switch device. Interface module 514 may include circuitry for a wireless communication interface, or may have a wired interface such as X10 interface. X10 is a communication protocol for sending and receiving signals in the form of short RF bursts over existing 120V AC wiring in a building without having to use additional wiring to build a remote control network for various appliances. Device 500 is thus well-suited for quickly building up a new RFID network. It can also integrate easily into a customer's existing network infrastructure to expand network range and capability.

Note that elements of the embodiments of FIGS. 3-6 (and other embodiments described herein) may be combined in any manner. For example, device 600 may include reader network interface module 514, although not shown in FIG. 6. A network-enabled device 600 is useful to set up a reader network temporarily and instantly such as for outdoor product demonstration and/or selling, where standard AC power receptacles are unavailable.

### Example RFID Smart Reader Antenna Application Embodiments

The present invention is applicable in any number of apparatus and system embodiments. For illustrative purposes, the description below refers to incorporating RFID interrogation devices 300 and 400 of FIGS. 3 and 4 into example systems and apparatuses, such as appliances and mobile devices. However, as would be apparent to persons skilled in the relevant art(s), any of the embodiments shown in FIGS. 3-6 (and the other embodiments described herein) can be incorporated into system and apparatus embodiments.

For example, FIG. 7 shows an RFID-enabled mobile hand-held apparatus 700, comprising a hand-held mobile unit 710 and RFID interrogation device 300. Device 300 may be incorporated within mobile unit 710 (e.g., in a card format), or it can be a detachable module which can be fitted onto mobile unit 710 as needed. Mobile unit 710 may be a mobile phone, a personal digital assistant (PDA), or a laptop computer, for example. In the embodiment of FIG. 7, device 300 may have its own power supply, or it may be adapted to draw power from local power source 740 of mobile unit 710, such as a battery. Device 300 includes an interface, such as a USB port, and any necessary hardware, software, and/or firmware for interfacing with apparatus 700. Apparatus 700 includes hardware, software, and/or firmware for performing its functions, such as a processor 720, a storage module 730, and one or more peripherals 750 of mobile hand-held unit 710. As an example, mobile unit 710 may be a personal digital assistant (PDA), which can be converted into a mobile RFID reader when device 300 is attached.

In conventional applications, RFID systems have stationary readers interrogating mobile tags. Mobile readers such as mobile hand-held apparatus 700 eliminate such constraints, and improve the flexibility of RFID technology significantly. Mobile readers are useful for many business purposes, such as routine meter reading for energy utility companies, maintenance or repair of outdoor equipment for telecom or cable service providers, etc. Field technicians may carry an RFID-enabled PDA which stores a database of service history or repair instructions for particular equipment which has a RFID tag associated with it. The mobile RFID reader collects identification data from the tag, and communicates the identification data to the PDA. The PDA can be used to search a relevant database using the identification number, and display any resulting information and/or instructions on the PDA screen.

In another embodiment, a “shelf-reader” is described. FIG. 8 shows a shelf reader system 800, according to an embodiment of the present invention. As shown for system 800 in FIG. 8, device 400 is mounted to a shelf 810. Shelf reader system 800 is used to track items 820a-c, which are members of an exemplary population of items, supported by a rack or shelf 810. Each of items 820 has a RFID tag 102 attached, which transmit respective response signals 112 when interrogated by device 400. Device 400 may be plugged into a power outlet built into shelf 810 or in close vicinity to shelf 810. Alternatively, device 400 may be battery powered. There may be multiple shelves 810 in a target environment, such as in a warehouse, each having an associated device 400.

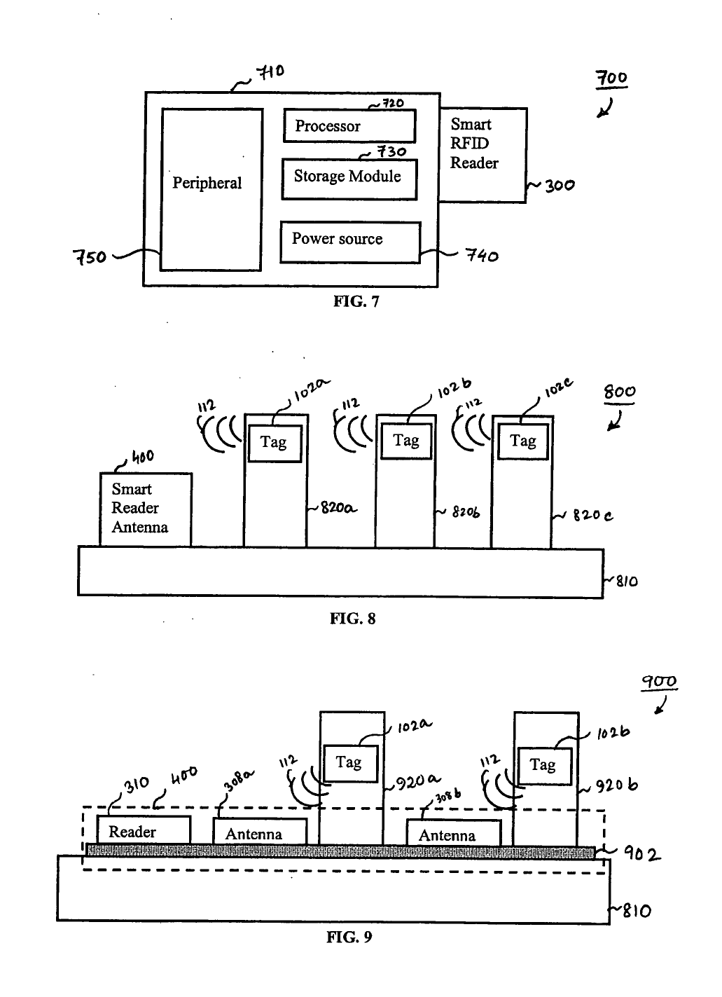

FIG. 9 shows a shelf-reader system 900, according to another embodiment of the present invention. In the embodiment of FIG. 9, device 400 includes a substrate 902 that covers a substantial portion of, or all of shelf 810, to which device 400 is mounted. For example, substrate 902 may be made of a flexible material, so that it can be rolled out to cover shelf 810. Items 920a-b are placed on substrate 902 on shelf 810. One or more antennas 308 (e.g., antennas 308a and 308b) on substrate 902 may be distributed at different locations of substrate 902 to provide coverage along shelf 810. Each of antennas 308 are electrically coupled to reader IC chip 310 of substrate 902. Each of antennas 308 may have a limited range of operation, covering one or a few tagged items 920 on shelf 810. However, having antennas 308 distributed in the above described manner enables the interrogating of a population of tagged items 920 on shelf 810, utilizing only one device 400.

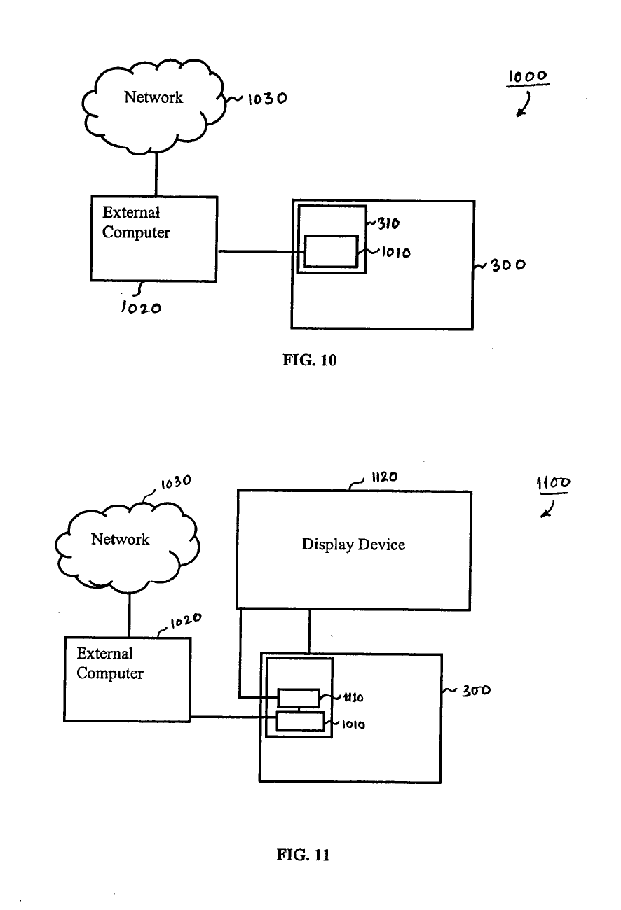

FIG. 10 shows a further embodiment of the smart RFID reader of the present invention. FIG. 10 shows a smart reader system 1000. System 1000 includes RFID interrogation device 300 that has a computer interface module 1010. Module 1010 may be incorporated in the reader IC chip 310, as shown FIG. 10. Alternatively, module 1010 may be incorporated in a different IC chip (e.g., ASIC) on substrate 302. Computer interface module 1010 enables device 300 to be capable of connecting to a computer 1020 external to substrate 302. Computer 1020 may store a database of information in its local drive and/or it may be connected to a network 1030. Network 1030 may be the Internet or a local server network. In a wireless embodiment, module 1010 may include an IEEE 802.11 WLAN interface, for example.

For example, in an embodiment, computer 1020 receives RFID information from the device 300, such as identification data read from an RFID tag. Computer 1020 has hardware/software (e.g., “middleware”) installed, so that it can access a database hosted on a remote server, such as a web-based server, containing corresponding relevant information to process the collected RFID data. Computer 1020 receives information and/or instructions from the remote server. Computer 1020 executes a local application based on the information/instruction(s) received from the remote server database, and transmits the processed data to device 300.

FIG. 11 shows an example smart reader system 1100 similar to system 1000 of FIG. 10, and integrating further functionality. In system 1100, device 300 includes a display interface module 1110. A display device 1120 is connected to device 300 via display interface module 1110. When computer 1020 transmits processed data to device 300, device 300 displays the data on a display screen of display device 1120. For example, in a shelf reader embodiment, such as described above with respect to FIGS. 8 and 9, the interrogating device may collect identification data from a tag associated with an item, and send the data to computer 1020. Computer 1020 accesses a price database located at a remote server, receives price information in the database related to the item from the remote server, and sends the price information to device 300. Display interface module 1110 of device 300 then causes display device 1120 to display the price information related to the item on display device 1120. In this manner, displayed price information for items on sale, such as items on sale in a grocery store, can be periodically updated automatically, without user interaction. Further or alternative product-specific information, such as number of items left in the inventory, next available shipment date, etc., can also be requested and displayed in a similar fashion, either automatically or on demand.

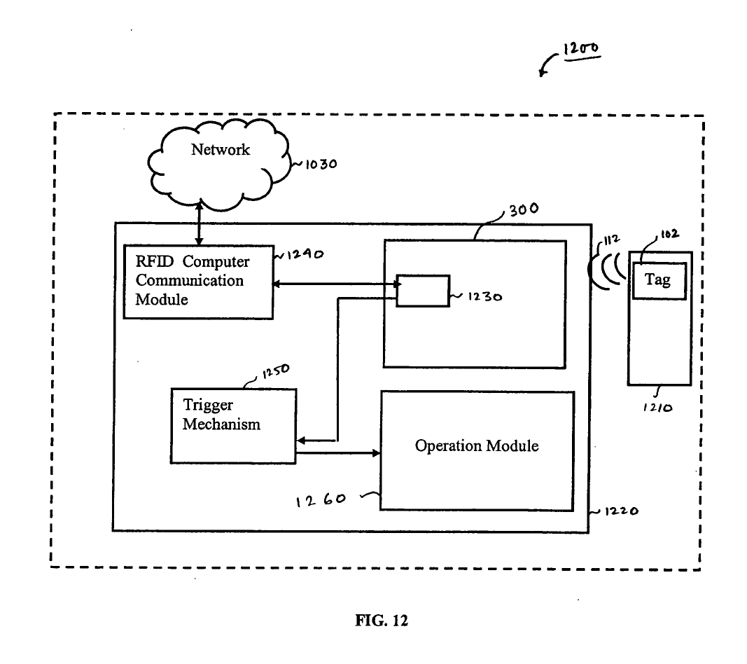

The present invention also relates to RFID-enabled smart appliances. FIG. 12 shows an example RFID-enabled smart appliance 1200, according to an embodiment of the present invention. Appliance 1200 has a housing 1220 that incorporates a built-in card that comprises RFID interrogation device 300. For example, substrate 302 of device 300 may be a rigid printed circuit board or circuit card. Alternatively, housing 1220 may have a receptacle where the card may be inserted. Furthermore, appliance 1200 may include the following optional components: a computer communication module 1240, a trigger mechanism 1250, and an operation module 1260.

As shown in FIG. 12, device 300 includes IC chip 310, which includes an appliance interface module 1230. Appliance interface module 1230 interfaces device 300 with appliance 1200. Appliance interface module 1230 includes hardware, software, and/or firmware as required to perform its functions.

Appliance interface module 1230 can perform a variety of interfacing functions. For example, appliance interface module 1230 can enable device 300 to communicate with an external computer system. After device 300 interrogates a tag corresponding to an item 1210, and receives identifying data in the response signal from the tag, device 300 transmits the identifying data to RFID computer communication module 1240 via interface module 1230. Computer communication module 1240 communicates with a remote computer system via network 1030, and receives information and/or instructions specific to the tagged item from the remote computer system. Computer communication module 1240 transmits the information/instructions to device 300. When instructions are received, device 300 transmits the instructions to trigger mechanism 1250. Trigger mechanism 1250 includes hardware, software, and/or firmware for performing its functions. Trigger mechanism 1250 is configured to direct the operation of appliance 1200 via operation module 1260. Operation module 1260 comprises hardware, software, and/or firmware for at least some operation of appliance 1200.

Appliance 1200 may be any common office or home appliance, such as a microwave oven, a stove, a television, a compact disc (CD) player, a digital video disc (DVD) player, a clock, a refrigerator, etc. For illustrative purposes, a specific example, namely a smart RFID-enabled DVD player application for appliance 1200 is described as follows. An operator inserts a particular DVD containing a movie into the smart DVD player of appliance 1200. The DVD has an associated RFID tag, which transmits its identification number to device 300 of the DVD player when interrogated by device 300. The specific movie of the DVD is thereby identified, such as by device 300 querying a movie database hosted locally in computer communication module 1240, or in a remote server of network 1030.

When specific information and/or instructions for the particular movie is received from the database, device 300 signals trigger mechanism 1250 to cause operation module 1260 to operate accordingly. For example, operation module 1260 may be caused to adjust the color, sound level, etc., output by the DVD player, as optimally recommended for watching the particular DVD. In a further example, operation module 1260 can be caused to turn on subtitles in an appropriate language if the movie of the DVD is identified as a foreign language movie. Furthermore, computer module 1240 or network 1030 may be caused by device 300 to update a personal database for the operator of the DVD player, for example, to track a list and/or genre of movies the operator has been watching over a period of time, etc., so that the smart DVD player of the present invention can automatically notify the operator when a similar movie becomes available at a local store.

In another example of a smart appliance 1200, an RFID-enabled washing machine may be able to adjust the water level, water temperature, washing time, etc., depending on instructions supplied by device 300, which collects identification information from a RFID-tagged washing load (e.g., including one or more tagged clothing items). Many further applications for appliance 1200 will be apparent to persons skilled in the relevant art(s) from the teachings herein.

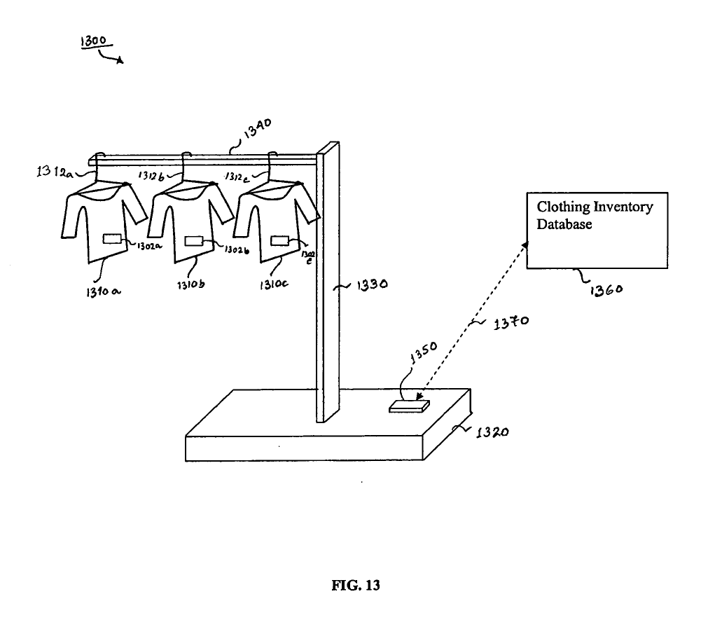

FIG. 13 illustrates another example application of the smart reader antenna, which may be realized in a retail environment, for example in clothing retail. FIG. 13 shows a smart reader antenna system 1300. The smart reader antenna system 1300 depicted in FIG. 13 can be termed as a “rack reader”. System 1300 includes a rack structure comprising a base 1320, a post 1330, and a bar 1340. Any number of clothing items 1310 are hung from the rack. Each of clothing items 1310 has a RFID tag 1302 attached. FIG. 13 shows three clothing items 1310a-1310c with tags 1302a-1302c respectively, hanging from hangers 1312a-1312c. System 1300 also includes a smart RFID reader 1350 coupled to a clothing inventory database 1360 via a communication channel 1370.

The “rack reader” may be structurally and functionally similar to the shelf reader system depicted in FIG. 8. Smart reader 1350 is housed or affixed to the rack either on its base 1320 (as shown in FIG. 13) or on any other part of the rack structure, such as on the post 1330 or the bar 1340, or any additional structure not shown on FIG. 13 that may be a part of the rack. In an embodiment where the entire rack or any part of the rack (such as 1320, 1330, and/or 1340) is made of a conductive metal, the rack itself can be used as an RFID antenna coupled to the reader 1350, or can be configured as an extension of an existing antenna of reader 1350.

Reader 1350 communicates with the clothing inventory database 1360. For example, whenever a customer or a store employee removes or adds any clothing item 1310 from the rack, the reader updates clothing inventory database 1360 appropriately. Also, similarly to the systems described in FIGS. 10 and 11, reader 1350 can interrogate and receive information/instructions from clothing inventory database 1360, and display that information to the user using a display coupled to reader 1350. The display (not shown in FIG. 13) may be mounted on the rack structure of system 1300 so as to be visible to customers and/or store employees.

### Example Network Embodiments

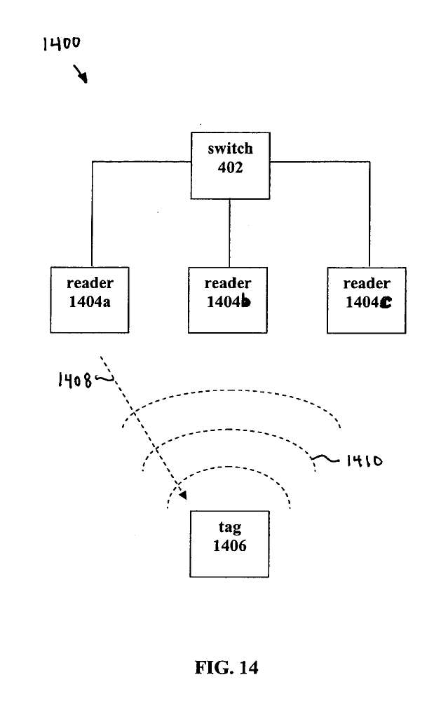

Readers, including the smart reader antennas of the present invention, may be networked in various ways to improve coverage of tagged items in the environment. For example, FIG. 14 shows a networked system 1400, according to an example embodiment. System 1400 includes an RFID switch 1402 coupled to readers 1404a-c. For example, readers 1404a-c may be one or more of the readers described elsewhere herein. Readers 1404a-c communicate with one or more tags, such as tag 1406. Tag 1406 may be coupled to an item (e.g., a product), not shown in FIG. 14.

In embodiments, functions related to RFID communications with tags are split between switch 1402 and readers 1404. For example, in embodiments, switch 1402 is a device that includes one or more functions, including one or more of handling protocol-level functions, sending digitally encoded tag interrogation commands/instructions (e.g., optionally including parameters) to readers 1404, receiving digitally encoded tag responses from readers 1404, handling acknowledgements, isolating data in signals received from tags by readers 1404, etc. In embodiments, readers 1404 include one or more functions, including one or more of receiving digitally encoded tag interrogation commands from switch 1402, converting the digital tag interrogation commands into analog (e.g., RF) form, providing power amplification (e.g., using a power amplifier), pulse shaping, transmitting RF signals to tags, receiving tag responses, converting the tag responses to digital form, and transmitting the digital tag responses to switch 1402. Thus, in an embodiment, readers 1404 may include analog-to-digital (A/D) conversion and/or digital-to-analog (D/A) conversion functionality.

Readers 1404 may be coupled to switch 1402 in various ways, including by wireless or wired connections. For example, readers 1404 may be coupled to switch 1402 by an Ethernet connection, special network cables, or by other types of links. In an Ethernet connection embodiment, one or more readers 1404 may include an Ethernet controller.

Switch 1402 may be coupled to a remote computer or computer network by one or more wired or wireless links, including any type of communications link or interface described elsewhere herein (such as for devices 300, 400, 500, and 600, above). For example, the computer network may be the Internet or a local server network. In a wireless embodiment, switch 1402 may include an IEEE 802.11 WLAN interface, for example. Furthermore, in embodiments, signals may be transmitted between switch 1402 and readers 1404 in various forms, including continuous data streams, data packets, etc.

During operation, reader 1404a may interrogate tag 1406 by transmitting an RF interrogation signal 1408 thereto. The interrogation may occur as a result of an instruction from switch 1402 to reader 1404a. Tag 1406 may transmit a response 1410 to reader 1404a. However, other readers within communication range of tag 1406 may receive response 1410, such as readers 1404b and 1404c. Thus, according to an embodiment of the present invention, any or all of readers 1404a-c may transmit the received response 1410 to switch 1402. In this manner, switch 1402 can utilize one or even more sources of response 1410 when compiling and analyzing response 1410, because readers 1404a-c are all in range of tag 1406 and are capable of receiving and providing response 1410 to switch 1402.

Thus, in an embodiment of the present invention, a first reader can transmit an interrogation signal to one or more tags, and one or more other readers may receive the tag response(s), and provide them to a central location (e.g., through a switch 1402) for processing. This is useful for obtaining a response of a tag that may not be located or oriented properly for providing a response that can be successfully received by the first reader. For example, the one or more other readers may be positioned better to receive the tag response to the first reader interrogation.

Furthermore, system 1400 may be use to determine a location of tag 1406. For example, switch 1406 may perform a conventional location determining technique (e.g., triangulation) to determine the location of tag 1406 based on one or more responses to interrogation signal 1408 received by readers 1404a-c. In a similar fashion, movement of tag 1406 may be monitored/tracked by transmitting a transmitting periodic interrogation signals 1408 from a first reader, and receiving corresponding responses 1410 of tag 1406 at multiple readers 1404a-c, as tag 1406 moves (or does not move).

Further, system 1400 may be used to determine an existence of a rogue RFID reader. For example, readers 1404b and 1404c receive interrogation signal 1408 transmitted by reader 1404a, and transmit an indication of receiving signal 1408 to switch 1402. Readers 1404b and 1404c may transmit any signal they receive to switch 1402, including signals from reader 1404a and other reader (known and unknown) in the environment. Upon receipt of these signals from readers 1404b and 1404c, switch 1402 can analyze and determine a source of the signals. If switch 1402 cannot identify the source of a particular signal, it may determine that the signal source is a rogue RFID reader that is transmitting signals in the local vicinity. Thus, corrective action may be taken by system 1400, by an operator associated with system 1400, or otherwise, to remove and/or reduce the influence of the rogue reader.

Still further, system 1400 may be used to determined background noise. For example, as described above, reader 1404b may have received response 1410 and transmitted it to switch 1402. However, due to background noise, response 1410 may have been corrupted. Switch 1402 may detect the corruption to response 1410 received by reader 1404b, and determine that an area around reader 1404b is suffering from unwanted interference. Corrective measures can then be taken by switch 1402, an operator of system 1400, or otherwise.

In an embodiment, reader 1404a can be considered an “interrogation” reader, that sends interrogation commands, while readers 1404b and 1404c are considered “listen” readers. “Listen” readers (e.g., readers 1404b and 1404c) may each transmit a low power continuous wave (CW) signal that is modulated by tag 1406, due to tag 1406 already responding to interrogation signal 1408. This enables the listen readers to better received response 1410. Furthermore, such an implementation enables the reading of “contended” time slots in dense reader systems. In other words, if more than one tag responded to interrogation signal 1408, the presence of multiple “listen” readers enables the multiple tag responses to be successfully be received, such as by receiving different ones of the tag responses at different “listen” readers.

In such an embodiment, the “listen” readers may transmit a different frequency CW signal than is transmitted by the interrogation reader. The CW frequencies transmitted by the “listen” readers may be different from each other. If multiple tags respond to interrogation signal 1408, the spatial separation of the tags will provide different strength signal levels in their responses to the differently positioned “listen” readers. Typically, a response signal of a tag will be received most strongly by the nearest “listen” reader to the tag. In this manner, the “contending” tags can be read, each contending tag being read by its nearest “listen” reader. In a Gen 2 embodiment, the resulting RN16 information in the tag response can be used by switch 1402 to command the interrogation reader (e.g., reader 1404a) to use multiple ACKs (acknowledgment command) so that each contending tag can read out their respective identification (ID) number.

Alternatively, in the Gen 2 embodiment, instead of using the ACK command to retrieve the ID numbers, the tags can be commanded to transmit their ID numbers immediately upon receipt of a Query command. The presence of multiple “listen” readers will enable the multiple ID numbers of contending tags to be successfully read.

Such an embodiment in a Gen 2 environment has benefits, such as enabling lower “Q” values. The “Q” value dictates how many time slots are present in which tags can respond. If a lower “Q” value can be supported, fewer time slots result, and the tag population can be read faster. In an example embodiment, the interrogation reader can transmit a lower Q value to the tag population, giving fewer total slots, and resulting in a higher proportion of contended slots. For example, a “Q” value could be selected to lead to an average of 3 tags responding per time slot. However, according to the present embodiment, all 3 tags may be read using the multiple “listen” readers, even though this is significant contention. This provides an approximately 10-times better performance when compared normal Gen 2 protocol operation. This is because (a) the ACK command is no longer needed, and (b) an average of only ⅓ tag responding per time slot is all that can be normally handled in a Gen 2 system.

### Conclusion

From the above description, it is evident that the present invention is of great utility for a wide range of RFID technology applications.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A radio frequency identification (RFID) device, comprising:
a substrate;
at least one antenna on the substrate;
at least one integrated circuit chip mounted on the substrate and electrically coupled to the at least one antenna; and
at least one electrical power interface module mounted on the substrate and electrically coupled to the at least one integrated circuit chip;
wherein the at least one integrated circuit chip comprises a RFID reader module that is configured to generate read signals that are transmitted by the at least one antenna to RFID tags, and is configured to decode read response signals from the tags received by the at least one antenna.

2. The RFID device of claim 1, further comprising a housing that encloses the substrate, the at least one antenna, the integrated circuit chip, and the electrical power module.

3. The RFID device of claim 1, wherein the integrated circuit chip further comprises a reader network interface module.

4. The RFID device of claim 1, wherein the reader network interface module is a wireless interface to a reader network.

5. The RFID device of claim 1, wherein the reader network interface module comprises an X10 interface.

6. The RFID device of claim 1, wherein the electrical power module is configured to interface with a power source external to the substrate.

7. The RFID device of claim 1, wherein the electrical power module comprises a battery.

8. The RFID device of claim 1, wherein the RFID device is configured to be incorporated in a mobile handheld device.

9. The RFID device of claim 10, wherein the mobile handheld device is a cell phone, a personal digital assistant (PDA), or a laptop computer.

10. The RFID device of claim 1, wherein the substrate is a flexible substrate.

11. The RFID device of claim 1, wherein the substrate is capable of being rolled onto a shelf, the shelf supporting at least one item having an associated RFID tag.

12. The RFID device of claim 1, wherein the at least one integrated circuit chip further comprises a computer interface module that interfaces with a computer system external to the substrate.

13. The RFID device of claim 12, wherein the computer interface module receives operational instructions specific to at least one RFID tag from the computer system.

14. The RFID device of claim 12, wherein the at least one integrated circuit chip further comprises a display interface module that interfaces with a display device.

15. The RFID device of claim 14, wherein the computer interface module is configured to transmit data received from an RFID tag by the RFID reader module to the external computer system, and to receive a response to the transmitted data from the computer system;
wherein the display interface module is configured to provide information received in the response to the display device for display.

16. The RFID device of claim 1, further comprising an appliance interface module that interfaces the RFID device with an appliance, wherein the appliance interface module directs an operation of the appliance according to data received from an RFID tag by the RFID reader module.

17. The RFID device of claim 1, wherein the at least one integrated circuit chip is a single application specific integrated circuit (ASIC) chip.

18. An apparatus, comprising:
a radio frequency identification (RFID) card, comprising:
a substrate;
at least one antenna on the substrate;
at least one integrated circuit chip mounted on the substrate and electrically coupled to the at least one antenna;
at least one electrical power interface module mounted on the substrate and electrically coupled to the at least one integrated circuit chip; and
wherein the at least one integrated circuit chip comprises a RFID reader module that is configured to generate read signals that are transmitted by the at least one antenna to RFID tags, and is configured to decode read response signals from the tags received by the at least one antenna.

19. The apparatus of claim 18, wherein the apparatus comprises an appliance.

20. The apparatus of claim 19, further comprising an appliance interface module that interfaces the appliance with the RFID card, wherein the appliance interface module directs an operation of the appliance according to data received from an RFID tag by the RFID reader module.

21. The apparatus of claim 20, wherein the appliance is a washing machine, a microwave, a refrigerator, a stove, a clock, a lamp, television, a computer, a compact disc player, a DVD player, or a radio.

22. The apparatus of claim 18, wherein the apparatus comprises a mobile handheld device.

23. The apparatus of claim 22, wherein the mobile handheld device is a cell phone, a personal digital assistant (PDA), or a laptop computer.

24. A radio frequency identification (RFID) reader network, comprising:
a first reader;
a second reader; and
a switch coupled to the first and second readers;
wherein the first reader is configured to transmit an interrogation signal to a population of RFID tags;
wherein the second reader is configured to receive at least one tag response to the interrogation signal; and
wherein the second reader is configured to transmit data of the at least one tag response to the switch.

25. The network of claim 24, further comprising a third reader coupled to the switch;
wherein the third reader is configured to receive the at least one tag response, and to transmit a second data of the at least one tag response to the switch.

26. The network of claim 25, wherein the first data and the second data are used to determine a location of a tag of the population of RFID tags.

27. The network of claim 25, wherein the first data and the second data are used to determine monitor movement of a tag of the population of RFID tags.

28. The network of claim 25, wherein the first data includes a first identification number of a first tag of the population of tags, and the second data includes a second identification number of a second tag of the population of tags, wherein the first and second identification numbers are received during the same time slot.

29. The network of claim 24, wherein the switch is configured to analyze the data to determine whether the at least one tag response is corrupted.

30. The network of claim 29, wherein the switch is configured to determine that an area in a communication range of the second reader is suffering from unwanted interference if the switch determines that the at least one tag response is corrupted.

31. A radio frequency identification (RFID) reader network, comprising:
a first reader; and
a switch coupled to the first reader;
wherein the first reader is configured to transmit a first interrogation signal to a population of RFID tags;
wherein the first reader is configured to receive at least one tag response to the first interrogation signal;
wherein the first reader is configured to receive interrogation signals from other readers;
wherein the first reader is configured to transmit information indicating receipt of an interrogation signal received from another reader to the switch.

32. The network of claim 31, wherein the switch is configured to analyze the information to determine a source of the interrogation signal received by the first reader from another reader; and
wherein the switch is configured to determine that the another reader is a rogue reader if the source of the interrogation signal received by the first reader from another reader cannot be determined.
